(19) United States
(12) Patent Application Publication
(10) Pub. No.: US 2009/0255678 A1
(43) Pub. Date: Oct. 15, 2009

(54) Water Treatment by Chemical-Mechanical Process

(76) Inventors: Randy Rosine, Duncan, OK (US); Johanna Haggstrom, Duncan, OK (US); Michael McCabe, Duncan, OK (US)

Correspondence Address: ROBERT A. KENT, P.O. BOX 1431, DUNCAN, OK, 73536, US

(21) Appl. No.: 12/483,797

(22) Filed: Jun. 12, 2009

Related U.S. Application Data
(63) Continuation-in-part of application No. 11/899,299, filed on Sep. 5, 2007.

(51) Int. Cl. C02F 1/70; C02F 1/52; C02F 1/72; E21B 43/25; E21B 43/16

(52) U.S. Cl. 166/305.1; 210/702; 210/719; 210/721; 210/722; 210/709; 210/724; 210/198.1

(57) ABSTRACT

Systems and methods for treating aqueous fluids and their associated methods of use are disclosed. In one embodiment, a method comprises providing an untreated aqueous fluid with a first concentration of a contaminant. The method further comprises chemically treating the aqueous fluid to precipitate at least a portion of the contaminant. The method further comprises mechanically treating the aqueous fluid to remove at least some of the precipitated contaminant from the aqueous fluid, and to produce a treated water with a second concentration of the contaminant, wherein mechanically treating the aqueous fluid comprises flowing the aqueous fluid through a centrifuge. The method further comprises placing the treated water in a first well bore of the well treatment operation.

### CROSS REFERENCE TO RELATED APPLICATIONS

This application is a continuation-in-part of co-pending U.S. patent application Ser. No. 11/899,299, filed Sep. 5, 2007, which is herein incorporated by reference.

### BACKGROUND

The present invention relates to aqueous fluids associated with subterranean applications, and, at least in some embodiments, to novel systems and methods for treating aqueous fluids and their associated methods of use.

Generally, in the production of desirable fluids—such as oil or gas—from subterranean formations, large quantities of aqueous fluids may be produced. Often referred to as “produced water,” sources of such aqueous fluids may include fluids that have been injected into the subterranean formation as part of a well completion or well treatment process, fluids that may have been injected as part of an injection well driving process, connate fluids, formation fluids, and any mixture of any of these. Produced water may be brackish or saline or may contain hydrocarbon or undesirable solid materials. In some instances, for every barrel of oil produced from a well, about ten barrels of water may be produced along with that oil. Large quantities of produced water may be disposed of as waste water, for example, by reinjecting the produced water into a well. Produced water may require additional handling procedures with additional operation costs, such as storage, disposal, and environmental recovery.

Generally, large quantities of fluid may be required in subterranean applications, such as well treatment operations. For example, a single fracturing operation may require several millions of gallons of fluids to be injected into the well. Sources of such fluids may include seawater, pond water, fresh water, connate fluids, formation fluids, and any other source of water. Certain operational or environmental guidelines may require that the fluid be substantially free of undesirable contaminants that would be particularly detrimental to the chemistry involved in such treatment operations. In some instances, the use of fresh water may be preferred. However, it may be costly and difficult to obtain such large quantities of fresh water at remote well sites. In other instances, operational or environmental guidelines may permit the use of fluid which contains an amount of undesirable contaminants higher than that of fresh water, but lower than that of the most readily available fluid source.

Such undesirable contaminants may be, for example, inorganic ions having a valence state of two (“divalent ions”). In many well treatment operations, the use of fluids with high concentrations of divalent ions may be particularly undesirable. As would be understood by one of ordinary skill in the art, such ions may interfere with the chemistry of forming or breaking certain types of viscous fluids that may be useful in various treatment operations. Of particular concern may be fluids with high concentrations of cations, including dissolved alkaline earth metal ions, and particularly calcium and magnesium ions, and dissolved iron ions. Fluids with high concentrations of anions, such as sulfate, may present further concern. Calcium ions tend to react with sulfate ions to produce calcium sulfate, which is an insoluble salt that tends to precipitate from solution. Strontium ions and barium ions may undergo similar reactions to produce sulfate salts. Thus, the more commonly encountered undesirable contaminants tend to be either an undesirably high concentration of calcium, strontium, or barium ions, or an undesirably high concentration of sulfate ions. Because of undesirable ion contaminants, fracturing fluids have traditionally required additional additives and/or treatments prior to use.

As another example, the undesirable contaminants may include borates. In many well treatment operations, the use of fluids with high or unknown concentrations of borates may be particularly undesirable for a number of reasons. For example, borate cross-linking may interfere with the desired chemistry for a particular treatment operation. However, borates may be naturally occurring in fresh water, seawater, connate fluids, and formation fluids, and thus borates may be commonly found in produced water. For example, borates may be used in the treatment of subterranean formation to selectively increase the viscosity of an aqueous treatment fluid, as used when fracturing a well and delivering proppant to a desired location. Following treatment, the produced water may contain a high concentration of borates.

### SUMMARY

The present invention relates to aqueous fluids associated with subterranean applications, and, at least in some embodiments, to novel systems and methods for treating aqueous fluids and their associated methods of use.

One embodiment of the present invention provides a method of treating an untreated aqueous fluid with a first concentration of a contaminant to produce a treated water with a second concentration of the contaminant. The method comprises chemically treating the aqueous fluid to precipitate at least a portion of the contaminant, wherein chemically treating the aqueous fluid comprises adding a chemical agent to the aqueous fluid. The method further comprises mechanically treating the aqueous fluid to remove at least some of the precipitated contaminant from the aqueous fluid, wherein mechanically treating the aqueous fluid comprises flowing the aqueous fluid through a centrifuge.

Another embodiment provides a system for treating an untreated aqueous fluid with a first concentration of a contaminant to produce a treated water with a second concentration of the contaminant. The system comprises a chemical treatment subsystem capable of precipitating at least a portion of the contaminant. The system further comprises a mechanical treatment subsystem capable of removing at least some of the precipitated contaminant from the aqueous fluid, wherein the mechanical treatment subsystem comprises a centrifuge.

Yet another embodiment provides a method of performing a well treatment operation. The method comprises providing an untreated aqueous fluid with a first concentration of a contaminant. The method further comprises chemically treating the aqueous fluid to precipitate at least a portion of the contaminant. The method further comprises mechanically treating the aqueous fluid to remove at least some of the precipitated contaminant from the aqueous fluid, and to produce a treated water with a second concentration of the contaminant, wherein mechanically treating the aqueous fluid comprises flowing the aqueous fluid through a centrifuge. The method further comprises placing the treated water in a first well bore of the well treatment operation.

The features and advantages of the present invention will be apparent to those skilled in the art. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 is a flow diagram illustrating a water treatment system according to an embodiment of the invention.

FIG. 2 is a cross-sectional view, illustrating a representative example of the structure of a hydrocyclone according to an embodiment of the invention.

FIG. 3 is a cross-sectional view, illustrating a representative example of the structure of a centrifuge according to an embodiment of the invention.

FIG. 4 illustrates of a mobile water treatment system according to an embodiment of the invention.

FIG. 5 illustrates of a mobile water treatment system according to an embodiment of the invention.

### DESCRIPTION OF THE PREFERRED EMBODIMENTS

The present invention relates to aqueous fluids associated with subterranean applications, and, at least in some embodiments, to novel systems and methods for treating aqueous fluids and their associated methods of use.

As used herein, “produced water” refers to aqueous fluids produced from a well, including fluids that may have been injected into a subterranean formation as part of a well completion or well treatment process, fluids that may have been injected as part of an injection well driving process, connate fluids, formation fluids, flow-back water, and any mixture of any of these.

As used herein, the term “treatment fluid” refers generally to any fluid that may be used in a subterranean application in conjunction with a desired function and/or for a desired purpose. The term “treatment fluid” does not imply any particular action by the fluid or any component thereof.

As used herein, the term “untreated water” refers to aqueous fluids from any source, but which are understood to be unsuitable for a given treatment operation due to the presence of unknown or substantial concentrations of any one or more undesirable contaminates, including, but not limited to: calcium ions, magnesium ions, iron ions, sulfate ions, borate ions, strontium ions, barium ions, or any combination thereof.

As used herein, the term “treated water” refers to water that has been treated according to any of the various treatment systems or methods according to the invention. The term “treated water” does not necessarily imply an absence of undesirable contaminates.

As used herein, the term “treatment stream” means a flow of liquid moving through any of the treatment systems or methods according to the invention, starting with a stream of untreated water, moving through the system or method, and ending with a stream of treated water.

As used herein, the terms “upstream” and “downstream” refer to the movement of a treatment stream through a treatment or system or method according to the invention, starting “upstream” with a stream of untreated water, moving “downstream” through the system or method, and ending with a stream of treated water.

As used herein, a substantial concentration of sulfate ions is defined as being equal to or greater than about 500 milligrams per liter (mpL); a substantial concentration of calcium or magnesium ions is defined as being equal to or greater than a combined total of about 2,000 mpL; a substantial concentration of iron ions is defined as being equal to or greater than about 10 mpL; a substantial concentration of borate is defined as being equal to or greater than about 5 mpL.

As used herein, the term “cut point size” of a hydrocyclone refers to a particle size, determined by the stated efficiency of the hydrocyclone. For example, the term “d50 cut point” refers to the particle size at which the hydrocyclone is about 50% efficient at removing particles.

The term “derivative” is defined herein to include any compound that is made from one of the listed compounds, for example, by replacing one atom in the listed compound with another atom or group of atoms, rearranging two or more atoms in the listed compound, ionizing one of the listed compounds, or creating a salt of one of the listed compounds.

In accordance with embodiments of the present invention, some methods of the present invention comprise providing untreated water to a treatment stream, chemically treating the treatment stream to precipitate undesirable contaminants, and mechanically treating the treatment stream to remove undesirable contaminants and produce treated water. In some embodiments, chemically treating the treatment stream may precipitate ions, and mechanically treating the treatment stream may remove solids. One of the many potential advantages of the methods of the present invention, only some of which are discussed herein, is that produced water may be treated in a simple and cost-effective manner. In general, for an aqueous fluid to be suitable for use in common treatment operations, pure seawater, fresh water, or potable water is not required. The methods of the present invention may provide suitable treated water when the minimum requirements are merely an aqueous fluid that meets operationally defined standards for concentrations of undesirable contaminants. For example, in some embodiments, the operational standards may require that the concentration of contaminants in the treated water be between about 2% and about 70% of the concentration of the contaminants in the untreated water. By way of example, in some operations, the concentration of contaminants in the untreated water may be about 3000 mpL, whereas the operational requirement may call for treated water with a concentration of contaminants of about 2000 mpL. The operational standards may address contaminants that would be particularly detrimental to the chemistry involved in such treatment operations, e.g., any substantial concentrations of one or more of the dissolved sulfate, calcium, strontium, barium, magnesium, iron ions, and/or borates. Another potential advantage is that the treated water may be reused in various well treatment operations. An additional potential advantage is that the methods may provide treated water which may be suitable for use in various well treatment operations, while being less complex or costly than some other methods of treating aqueous fluids. In areas subject to drought conditions, the methods of the present invention may be particularly advantageous by reclaiming and reusing water that otherwise would be discarded.

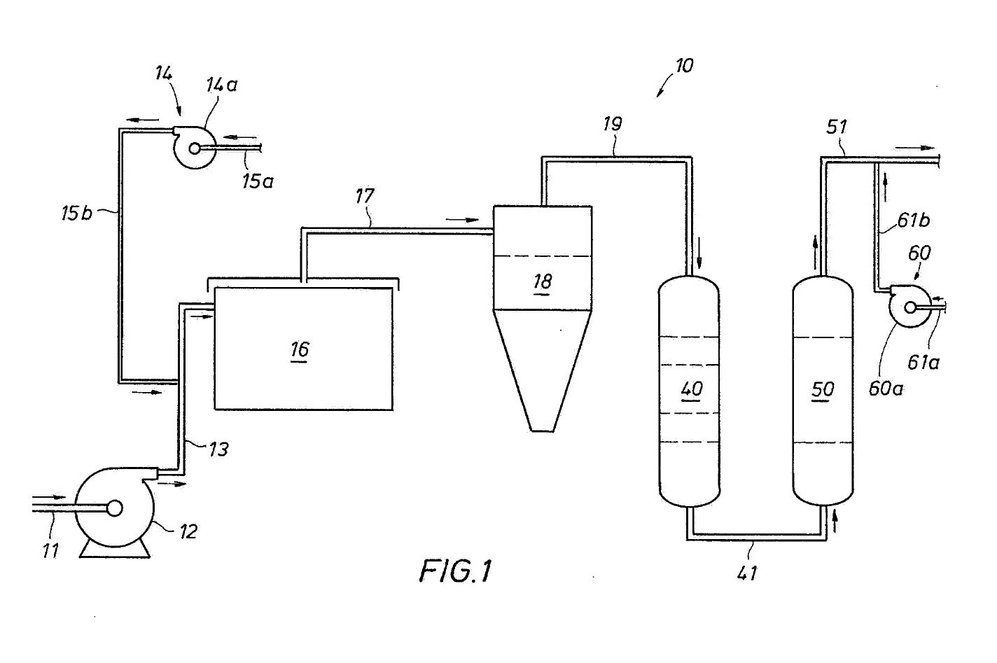

An example of a system for performing one or more steps of the methods of the present invention is illustrated in FIGS. 1-5 and is further described below. The steps also may be accomplished using any apparatuses suitable for doing so known in the art. None of the claims or elements thereof describing the methods of the present invention is limited to the system and/or components thereof described below.

Referring now to FIG. 1, a system 10 according to one embodiment of the invention may include an input pump 12. The input pump may be operatively connected to be capable of pumping a treatment stream through the system 10. The input pump 12 may be operatively connected to draw input fluid, such as untreated water, from a reservoir (not shown in FIG. 1), for example, via input piping 11 operatively connected to the input pump 12. The output of the pump 12 may be pumped downstream through pump outlet piping 13. The input pump 12 may be selected to meet the flow demands of the centrifugal separator 18 and the throughput of the system 10. Input pump 12 may be a high-capacity pump, for example, capable of pumping up to about 20 barrels per minute (“bbl/min”). According to the embodiment of system 10 shown in FIG. 1, the piping 13 may direct the treatment stream to the residence tank 16. It should be appreciated that residence tank 16 may be any tank, tub, pipe, or other reservoir that provides appropriate residence time.

Chemical-additive subsystem 14 may operate, among other things, to chemically treat the treatment stream to precipitate undesirable contaminants, such as, for example, ions. According to an embodiment of the invention, a chemical-additive subsystem 14 may comprise at least one liquid-additive pump, such as liquid-additive pump 14a, whereby various chemical agents in solution may be added to the treatment stream. The liquid additive pump 14a may be selected to meet the flow demands of the centrifugal separator 18, the throughput of the system 10, the relative contamination level of the untreated water, and the operational requirements for the treated water. Liquid additive pump 14a may comprise one or more relatively low capacity pumps compared to the input pump 12. For example, the liquid-additive pump 14a may be capable of pumping up to about 40 gallons per minute (“gal/min”). According to an embodiment of the invention, the various chemical agents to be added to the treatment stream may be dissolved in one or more solutions, which may be stored in one or more liquid storage tanks (not shown in FIG. 1). The liquid-additive pumps 14a may be operatively connected to such liquid storage tanks for chemical agents with suitable piping 15a.

The chemical-additive subsystem 14 also may comprise a means for mixing a chemical agent with the treatment stream. The means for mixing fluid streams from the liquid-additive pump 14a may comprise suitable liquid-additive piping 15b for combining the liquid-additive streams with the treatment stream in piping 13. The means for mixing the chemical agent with the treatment stream also may comprise selectively operable valves (not shown in FIG. 1) to assist in combining the various fluid streams. In certain embodiments, multiple chemical additive subsystems 14 may be used.

It will be understood by those of ordinary skill in the art with the benefit of this disclosure that other types of chemical additive mechanisms could be used, and such are contemplated by the present invention. For example, it is expected that solid chemical agents could be added using an auger dispensing system into the residence tank 16, which may be used for balancing fluid flows of the treatment stream between the input pump 12 and the centrifugal separator 18.

Chemical agents that may be suitable for certain embodiments of the invention include any agents that precipitate undesirable contaminants, for example, dissolved ions, thereby forming insoluble salts. In some embodiments, the chemical agents may include water-soluble sulfate ion precipitating agents, such as calcium, strontium, or barium halide; calcium-, strontium-, or barium-precipitating agents, such as carbonate, a water-soluble carbonate, or compounds comprising carbon dioxide and hydroxide; magnesium- and/or iron-precipitating agents, such as hydroxide, water-soluble alkali metal hydroxide or alkaline earth metal hydroxide; calcium-, strontium-, or barium-precipitating agents, such as water-soluble sulfate; and any combination thereof in any proportion. A person of ordinary skill in the art with the benefit of this disclosure would be able to select appropriate chemical agents based on factors such as the type and concentrations of undesirable contaminants present in the treatment stream, costs, supply and operational logistics, etc. For example, a calcium, strontium, or barium halide may be selected for reacting with and precipitating sulfate ions from the treatment stream. The resulting precipitate may comprise calcium, strontium, or barium sulfate. As another example, a carbonate may be selected for reacting with and precipitating dissolved calcium, barium, or strontium ions from the treatment stream. The resulting precipitate may comprise calcium carbonate, barium carbonate, or strontium carbonate. As a third example, a hydroxide may be selected for reacting with and precipitating magnesium and iron ions from the treatment stream. The resulting precipitate may be magnesium and iron hydroxide. It should be understood that other classes of chemical agents may be selected for various purposes. For example, it may be possible to precipitate magnesium with ammonium hydroxide to obtain water-insoluble magnesium hydroxide precipitate. However, the use of ammonium compounds may create hazardous conditions with possible release of ammonia gas into the atmosphere. The chemical agents also may include a flocculating agent, among other purposes, to assist in agglomerating particulate, including the particulate caused by the precipitation of insoluble salts. In some embodiments, a combination of a coagulating agent and a flocculating agent may be used. A person of ordinary skill in the art with the benefit of this disclosure would be able to select appropriate flocculating agents based on the characteristics of the untreated water. For example, in some embodiments, a suitable flocculating agent may be Alcomer® 120L, commercially available from Ciba® Specialty Chemicals Corp. of Suffolk, Va.

In some embodiments, additional chemical agents may be selected to adjust the pH of the treatment stream. In such instances, the chemical agents may include pH adjusting agents (e.g., pH increasing agents or pH decreasing agents). Suitable pH adjusting agents may include any that provide the desired pH adjustment, but which do not undesirably alter other properties of the treatment stream. For example, a water soluble hydroxide could be used as a pH increasing agent. In some embodiments, suitable pH adjusting agents may be capable of increasing the pH of the treatment fluid to at least about 8. For example, during precipitation of magnesium hydroxide or calcium carbonate, the pH may be adjusted to at least 8. In some embodiments, suitable pH adjusting agents may be capable of adjusting the pH of the treatment stream to the range of about 7 to about 12. In some embodiments, suitable pH adjusting agents may be capable of adjusting the pH of the treatment stream to the range of about 4 to about 8. The pH adjusting agent may be the same or different from one of the chemical agents selected to precipitate undesirable contaminants. It is within the ability of one skilled in the art, with the benefit of this disclosure, to determine whether and how much of a pH adjusting or agent may be helpful.

In addition, in certain embodiments, it may be desirable to add the chemical agents to the treatment stream in a particular order. For example, it may be desirable to add a chemical agent selected for being able to precipitate sulfate ions first. In such instances, if a calcium, strontium, or barium halide is employed to precipitate sulfate ions, it may be desirable to add carbonate downstream to precipitate calcium, strontium, or barium ions in solution. Without limiting the invention to a particular theory or mechanism of action, it is nevertheless currently believed that this may allow some time for mixing and reaction of the calcium, strontium, or barium halide with the dissolved sulfate ions prior to adding carbonate, which otherwise may pull some of the calcium, strontium, or barium halide out of solution in competition with the dissolved sulfate ions. In some embodiments, all of the chemical agents may be added simultaneously.

In some embodiments, the type and concentration of chemical agent to be added to the treatment stream may be selected to precipitate at least some undesirable contaminants of a particular type, while in other embodiments, the concentration may be selected to precipitate substantially all of the undesirable contaminants of a particular type. For example, calcium, strontium, or barium halide may be added to the treatment stream at a concentration which may be selected for the purpose of precipitating at least some of the dissolved sulfate ions in the treatment stream. For example, calcium chloride may be used as a chemical agent, and the concentration may be in the range of about 100% on a Molar basis of the concentration of the dissolved sulfate ions in the treatment stream. In some embodiments, because calcium, strontium, or barium ion is itself a divalent ion, it may be desirable not to use an excess of the calcium, strontium, or barium halide. Costs also may make it desirable not to use an excess of the calcium, strontium, or barium halide. In some embodiments, any excess of the calcium, strontium, or barium ion concentration in the treatment stream from the addition of calcium, strontium, or barium halide may be removed, for example, with the downstream addition of sufficient carbonate.

As another example, the type and concentration of chemical agent to be added to the treatment stream may be selected to remove substantially all undesirable contaminants such as dissolved calcium, strontium, or barium ions. In such instances, carbonate may be used as a chemical agent, and the concentration may be in the range of about 100% to about 120% on a Molar basis of the concentration of the dissolved calcium, strontium, and/or barium ions in the treatment stream.

As yet another example, water soluble alkali metal hydroxide and/or alkaline earth metal hydroxides may be used as a chemical agent to remove undesirable contaminants such as dissolved magnesium or iron ions. For example, water soluble hydroxide may be used as a chemical agent, and the concentration may be in the range of about 100% to 120% on a Molar basis of the concentration of the dissolved magnesium and/or iron ions in the treatment stream.

As would be understood by one of ordinary skill in the art with the benefit of this disclosure, the type and concentration of chemical agents selected may be influenced by factors such as the concentration of undesirable contaminants, e.g., ions and other impurities, in the untreated water, the operational requirements for concentration of undesirable contaminants in the treated water, the amount of time available to allow for full development of the kinetics of the reaction, the temperature of the treatment stream, etc. Once these factors are determined, basic stoichiometry may be utilized to estimate a required concentration of chemical agent. For example, if an operational requirement is to remove all of the magnesium in a treatment stream that contains about 2000 mpL of magnesium, the required stoichiometric concentration may be about 21 gallons per thousand gallons (“gpt”) of 25% sodium hydroxide solution. As previously discussed, the pH may need to be raised for complete precipitation, which may require a higher concentration of sodium hydroxide solution. Alternatively, if an operational requirement is to remove about half of the magnesium in a treatment stream that contains about 1800 mpL of magnesium, the required concentration may be about 9 gpt of 25% sodium hydroxide solution. In some embodiments, the required concentration may be higher than predicted from basic stochiometry. As another example, if the operational requirement is to reduce the amount of calcium in the treatment stream from about 11,000 mpL to less than about 500 mpL, about 50 gpt of 47% potassium carbonate solution may be required. Alternatively, if the operational requirement is to reduce the amount of magnesium in the treatment stream from about 2,600 mpL to about 1,400 mpL, about 10 gpt of 25% sodium hydroxide solution may be required. In some embodiments, sodium carbonate may be used alone or in combination with potassium carbonate to provide more cost-effective results. Without limiting the invention to a particular theory or mechanism of action, it is nevertheless currently believed that the excess may be required especially when insufficient time is permitted for full development of the slow kinetics and/or morphology in this reaction.

Referring back to FIG. 1, the residence tank 16 in the illustrated embodiment may be operatively connected upstream of the centrifugal separator 18. The residence tank 16 may, among other purposes, help balance the treatment stream from the input pump 12 in the piping 13 into the residence tank 16 with the treatment stream out of the residence tank 16 via tank output piping 17 toward the centrifugal separator 18. While output piping 17 may not be drawn to scale, it should be understood that particulates suspended in the treatment stream in piping 17 may settle over time. Excessive settling of particulates may impede the efficiency of centrifugal separator 18. Therefore, in embodiments wherein sufficient time and/or particulate settling occurs between the output of residence tank 16 and the input of centrifugal separator 18 to impede the efficiency of centrifugal separator 18, an optional mixer (not shown) may be inserted to re-suspend particulates prior to input of centrifugal separator 18. In other embodiments, a heater or cooler may be used in conjunction with piping 17 to accelerate or decelerate reactivity within the treatment stream. As would be understood by a person of ordinary skill in the art with the benefit of this disclosure, higher temperatures within the treatment stream in piping 17 would permit shorter residence time, therefore shorter length of piping 17. Alternatively, lower temperatures within the treatment stream in piping 17 may require longer residence time, therefore longer length of piping 17 in order to achieve efficient mechanical separation. Suitable residence times in piping 17 may vary from a few minutes to tens of hours.

The residence tank 16 may have sufficient volume to permit a non-uniform flow of liquid to be collected, mixed, and moved downstream at a more uniform rate. Pumping may be controlled by sensors in the residence tank (e.g., level, weight, volume, or depth sensors), and the pumping rates may be varied, for example, according to the depth of liquid in the residence tank.

The contents of the residence tank 16 may be mixed to prevent the settlement of solids and/or to ensure that the liquid quality is substantially uniform. To prevent anaerobic conditions and odors from developing in the residence tank 16, the contents of residence tank 16 may need to be aerated. Venturi aerators may be used to mix and aerate, while mixing propellers may be used to keep solids in suspension as the treatment stream moves through the residence tank 16.

In cases where the input fluid contains a high concentration of solids, such as in a mud, the system 10 may optionally include a conventional shaker separator (not shown in FIG. 1) operatively connected upstream of the centrifugal separator 18. In some embodiments, the shaker separator may be positioned upstream of the chemical-additive subsystem 14. In other embodiments, an optional skimmer may be positioned upstream of the chemical-additive subsystem 14 to remove oil from the treatment stream.

Referring again to FIG. 1, the system 10 may further include a centrifugal separator 18. According to the embodiment of system 10 shown in FIG. 1, the piping 17 may direct the treatment stream to the centrifugal separator 18.

Centrifugal separator 18 may operate, among other things, to mechanically treat the treatment stream to remove solids and produce treated water. The centrifugal separator 18 may remove relatively large particles from the treatment stream. For example, the centrifugal separator 18 may be capable of removing at least about 50% of the particles larger than about 300 microns that may be in the treatment stream. In some embodiments, the centrifugal separator 18 may be capable of removing over about 90% of the particles larger than about 300 microns that may be in the treatment stream. It should be understood that the centrifugal separator 18 may comprise a plurality of centrifugal separators to achieve a desired capacity of fluid flow and effectiveness. Moreover, the centrifugal separator 18 may be replaced by one or more mechanisms capable of separating liquids from solids in certain embodiments of the present invention. Suitable liquid-solid separation mechanisms may include belt presses, rotary vacuum dryers, diatomaceous earth presses, drum filters, canister filters, bag filters sand bed filters, gravitational separators, etc. A person of ordinary skill in the art with the benefit of this disclosure would be able to select an appropriate liquid-solid separation mechanism based on factors such as time allowable for separation, consistency and hardness of the solids, tendencies of the mechanism to plug, back-flush or other maintenance requirements of the mechanism, costs, and operational logistics.

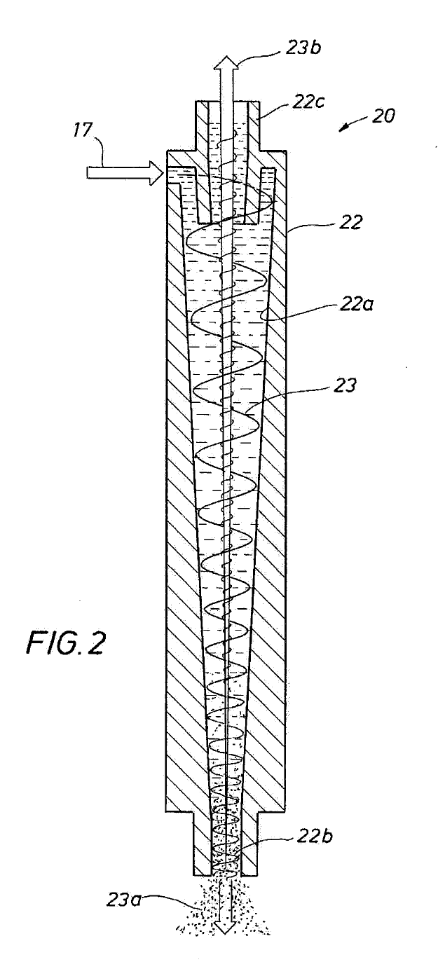

According to an embodiment of the invention, the centrifugal separator 18 may comprise a hydrocyclone 20, as illustrated in FIG. 2. Fluid containing solid particulates may be fed tangentially into the body 22 of the hydrocyclone 20 through piping 17. The inner wall 22a of the body of the hydrocyclone 22 may be in the shape of a cone with a smaller open end or spigot 22b of the cone shape oriented downward. The fluid fed tangentially into the body 22 of the hydrocyclone may cause a vortex fluid flow 23. Relatively larger or denser solid particulates may tend to be thrown to the inner wall 22a of the body 22 and to be discharged by gravity from the spigot 22b with a small amount of fluid as underflow 23a. Most of the fluid containing relatively fine solid particulates may discharge from the upper end of the body 22 of the hydrocyclone 20 via the vortex finder 22c as overflow 23b. The underflow 23a of fluid from the spigot 22b of the hydrocyclone body 22 may tend to contain particles coarser than the cut point size. The overflow 23b of fluid from the upper end of the hydrocyclone body 22 may tend to contain particles finer than the cut point size. In some embodiments, the hydrocyclone 20 may have a d50 cut point at least down to about 300 microns. In some embodiments, the hydrocyclone may have a d50 cut point down to about 100 microns. The overflow 23b from the hydrocyclone 20 may continue through a system or method according to the invention as part of the treatment stream.

It should be understood that, as an alternative to a hydrocyclone 20, a centrifugal separator of other types may be employed according to the principles of the invention. For example, a centrifuge may be employed for the centrifugal separator 18, whereby a substantially dry cake of solid particulates may be pulled out of the treatment stream. Examples of suitable centrifuges are a D4L decanter centrifuge and a D5L decanter centrifuge, each commercially available from The Andritz Group of Graz, Austria. As an alternative example, rotary vacuum dryers may be employed for the centrifugal separator 18.

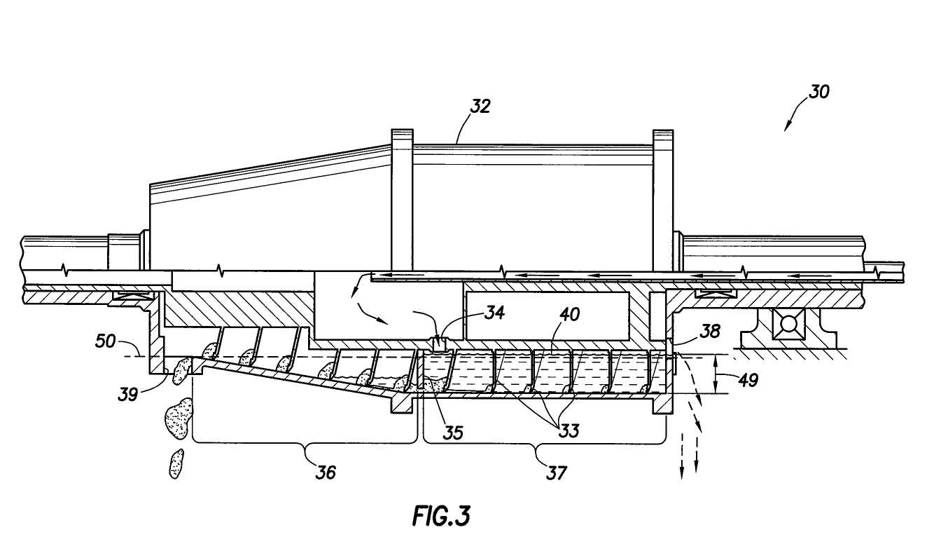

Referring now to FIG. 3, a centrifuge 30, which may be suitable for use in certain embodiments of the invention, is illustrated. The body of the centrifuge may define a generally cylindrical wall 32 and a screw-type conveyor 33. The threads of screw-type conveyor 33 may be solid from the hub of the conveyor 33 to the outer edge of the threads, or the threads may be solid only near the outer edge, connecting to the hub via spokes. In some embodiments, the threads may form an acute angle with the hub of the conveyor. A treatment stream may proceed through inlet 34, which may flow through an opening in the conveyor 33 to the space between the hub of the conveyer and the cylindrical wall 32, which space is sometimes referred to as the bowl of the centrifuge. A solids (dip) weir 35 may restrict the flow of particulates, providing a build-up of pressure on one side of the weir and improved particulate separation. The rotation of the conveyor may help separate the particulates from the fluid in the drying zone 36 of the bowl of the centrifuge, and fluid with a reduced particulate content may move through a liquid zone 37 of the bowl of the centrifuge toward outlet 38. Separated particulates (e.g., in the form of a caked mud) mud may be expelled through the outlet 39.

In some embodiments, centrifuge 30 may be operated in “super pool” conditions, wherein the depth 49 of pool 40 in the liquid zone 37 exceeds the spillover depth 50. As would be understood by one of ordinary skill in the art with the benefit of this disclosure, a solids (dip) weir 35 may be required to achieve super pool conditions. Moreover, during startup of system 10, liquid spillover may occur through outlet 39 until such time as solids build up at solids (dip) weir 35, thereby limiting the flow of fluids from liquid zone 37 to drying zone 36. In some embodiments, discharge from outlet 39 may be collected during startup of system 10 and re-processed. For example, discharge may be collected for a period of time up to about 15 minutes following startup.

Without limiting the invention to a particular theory or mechanism of action, it is nevertheless currently believed that, for a given centrifuge interior diameter (as measured on the interior of centrifuge wall 32 in liquid zone 37), a greater centrifuge length (as measured between centrifuge inlet 34 and fluid outlet 38) may allow for additional retention time and particulate build-up, and thereby provide more efficient removal of particles from the treatment stream. Similarly, it is believed that slower flow rates of the treatment stream through centrifuge 30 may allow for additional retention time and particulate build-up, and thereby provide more efficient removal of particles from the treatment stream. It is also believed that, for a given centrifuge length, a larger centrifuge interior diameter may allow for larger thru-flow without compromising retention time or particulate build-up. One of ordinary skill in the art with the benefit of this disclosure would understand that there may be a minimum flow rate at and below which particle removal efficiency dramatically decreases. In some embodiments, the centrifuge length may be between about 20 inches and about 100 inches and the centrifuge length-to-diameter ratio may be between about 2.5 and 4.5, with a corresponding pump rate between about 50 gal/min and about 180 gal/min. In some embodiments, the centrifuge length may be between about 55 inches and about 75 inches and the centrifuge length-to-diameter ratio may be between about 3.5 and 4.0, with a corresponding pump rate between about 90 gal/min and about 140 gal/min. In some embodiments, the centrifuge length may be between about 70 inches and about 80 inches and the centrifuge length-to-diameter ratio may be between about 3.5 and 4.0, with a corresponding pump rate between about 160 gal/min and about 180 gal/min. In certain embodiments, the centrifuge may be scaled to much greater dimensions (while maintaining the length-to-diameter ratio) to accommodate significantly higher pump rates, though operational logistics may provide an upper limit on the size of the centrifuge.

As would be understood by one of ordinary skill in the art with the benefit of this disclosure, the pool depth of the centrifuge may be adjusted, among other reasons, to provide for efficient liquid-solid separation. Factors that may influence selection of appropriate pool depth may include the concentration of undesirable contaminants in the untreated water and the operational requirements for concentration of undesirable contaminants in the treated water. Iterative trials may be performed to confirm the selection of the appropriate pool depth.

Output of the centrifugal separator 18, for example the overflow 23b from a hydrocyclone 20 or the outlet 38 from a centrifuge 30, may be directed downstream through outlet piping 19 from the centrifugal separator 18, as illustrated in FIG. 1. The system 10 may further include an optional polish filter 40. According to the embodiment of system 10 shown in FIG. 1, the piping 19 may direct the treatment stream to the polish filter 40.

In some embodiments, it may be desirable to connect residence tank 16 with polish filter 40 directly, thereby eliminating centrifugal separator 18 from the treatment stream. In such embodiments, particulate settling over time may be utilized to remove relatively large particles from the treatment stream. One of ordinary skill in the art with the benefit of this disclosure would be able to recognize embodiments for which this configuration would be suitable, based upon such factors as costs and operational logistics.

In the embodiment illustrated in FIG. 1, the polish filter 40 may be connected downstream of the centrifugal separator 18. The polish filter 40 may be capable of removing finer particulate sizes than certain centrifugal separators are capable of removing. In some embodiments, the polish filter 40 may be capable of removing particulate and precipitate as small as about 20 microns in size.

The polish filter 40 may comprise a mesh bag as a filter media. In some embodiments, the polish filter 40 may comprise at least two polish filters connected in parallel, for example, wherein the treatment stream may be selectively directed away from one polish filter so that the media of that polish filter may be replaced while continuing to direct the treatment stream to one or more other polish filters.

According to another embodiment of the invention, the polish filter 40 may comprise a backflushable tube filter, with one or more backflushable filtration tube filters for being able to by-pass while backflushing one filtration tube to one or more other backflushable filtration tubes.

Output of the polish filter 40 may be directed downstream through piping 41 toward an optional borate filter 50.

The borate filter 50 may be operatively connected downstream of the centrifugal separator 18 to filter the treatment stream. The borate filter 50 may be capable of removing at least some of a borate that may be present in the treatment stream when the treatment stream is at a pH of about 7 or above. In some embodiments, the pH of the treatment stream during passage through the borate filter 50 may be adjusted to be in the range of about 7 to about 12. In some embodiments, the pH of the treatment stream during passage through the borate filter 50 may be adjusted to be in the range of about 7 to about 8.

Borate filter 50 may comprise any filter media that is capable of removing borate from a treatment stream. Suitable filter media may include compounds that are capable of reacting with the borate. Such materials may be in a solid, water-insoluble form that can be maintained in a filter vessel while permitting the treatment stream to flow across the solid material. Without limiting the invention to a particular theory or mechanism of action, it is nevertheless currently believed that the cis-diols of cellulosic materials may perform well for labile addition of borate. In other embodiments, magnesium oxide may be used as a solid, water-insoluble material for removing borate from the treatment stream.

In some embodiments, the borate filter 50 may comprise a filter media comprising a cellulosic material. In certain embodiments, the filter media may comprise a cellulose material, a cellulose-based material (e.g., a cellulose derivative), a cellulose material derived from cellulose pulp, or any combination thereof in any proportion. Certain embodiments of the cellulose-based material comprise a microcrystalline cellulose, a powdered or granular cellulose, a colloidal cellulose, a surface-modified cellulose, any insoluble cellulose, or any combination thereof. Certain embodiments of the cellulose-based material may include chemically-unmodified forms of cellulose including, but not limited to, saw dust, wood shavings, and compressed wood particles.

According to another embodiment of the invention, the borate filter 50 may comprise a filter media that comprises magnesium oxide.

The borate filter 50 may comprise at least two borate filters connected in parallel, wherein the treatment stream may be selectively directed away from one borate filter, among other purposes, so that the media of the borate filter can be replaced while continuing to direct the treatment stream to one or more other borate filters.

Additional information regarding an example of a filter and method of filtration for removing borate from a fluid stream is disclosed in U.S. Patent Application Publication Nos. US 2006/0186050 and US 2006/0186033, both published on Aug. 24, 2006, and both having for named inventors Robert E. Hanes, David E. Griffin, and David E. McMechan, each of which is incorporated herein by reference in its entirety.

In some embodiments, if the pH of the treatment stream is not sufficiently high for the borate filtration step from the upstream addition of the chemical agents employed for precipitating ions prior to the centrifugal separator, additional or different chemical agents may be added upstream of the borate filter for that purpose. In this regard, the additional or separate pH increasing agent optionally may be added to the treatment stream upstream of the centrifugal separator or anywhere between the centrifugal separator and the borate filter.

Output of the borate filter 50 may be directed downstream through piping 51 toward a storage reservoir for treated fluid, such as treated water.

In some embodiments, the treatment stream may proceed through borate filter 50 prior to polish filter 40.

In some embodiments, the system 10 may further comprise a post-filtration chemical-additive subsystem 60, wherein the post-filtration chemical-additive subsystem 60 may be capable of selectively adding one or more chemical agents to the treatment stream downstream of the borate filter 50 between the borate filter and a storage reservoir for treated fluid. The chemical agents to be added downstream of the borate filter 50 may include, for example, a neutralizing agent to substantially neutralize the pH of the treatment stream, a bactericide, a surfactant, and any combination of the foregoing in any proportion or any other desired chemical agents or combination thereof. Additionally, decreasing the pH of the treatment stream may minimize residual fines remaining in the water phase, such as calcium carbonate or magnesium hydroxide.

According to an embodiment of the invention, post-filtration chemical-additive subsystem 60 may comprise at least one liquid-additive pump, such as liquid-additive pump 60a, whereby various chemical agents in aqueous solution may be added to the treatment stream. The liquid additive pump 60a may be a relatively low capacity pump compared to the input pump 12. For example, the liquid-additive pump 60a may be capable of pumping up to about 5 gal/min. According to an embodiment of the invention, the various chemical agents to be added to the treatment stream downstream of the borate filter 50 may be dissolved in one or more solutions, which may be stored in one or more liquid storage tanks (not shown in FIG. 1). The liquid additive pump 60a may be operatively connected to such liquid storage tanks for chemical agents with suitable piping 61a.

The post-filtration chemical-additive subsystem 60 may further comprise a means for mixing a chemical agent with the treatment stream. In some embodiments, the means for mixing fluid streams from the liquid-additive pump 60a may comprise suitable liquid-additive piping 61b for combining the liquid-additive streams with the treatment stream in piping 41. The means for mixing the chemical agent with the treatment stream may further comprise selectively operable valves (not shown in FIG. 1) to assist in combining the various fluid streams. In certain embodiments, multiple post-filtration chemical-additive subsystems 60 may be used.

Similar to the previous description with regard to the chemical-additive subsystem 14, it will be understood by those of ordinary skill in the art with the benefit of this disclosure that other types of chemical additive mechanisms could be used for the chemical-additive subsystem 60, and such are contemplated by the present invention.

According to an embodiment of the invention, the system 10 comprises appropriate fluid conduits or piping, such as piping 11, 13, 15a, 15b, 17, 19, 41, 51, 61a, and 61b, for operatively connecting together the various components of the system and for conducting the treatment stream through a system or method according to the invention. The appropriate size and materials for such conduits will be recognized by a person of ordinary skill in the art with the benefit of this disclosure.

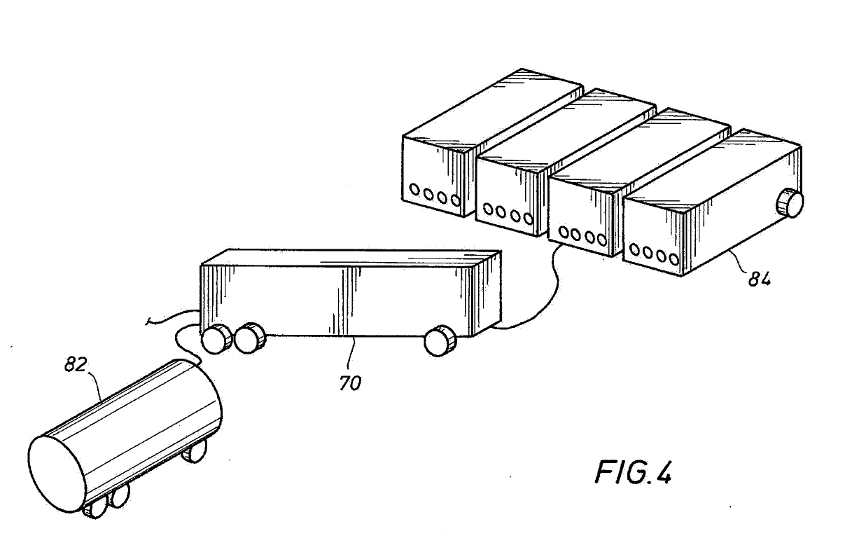

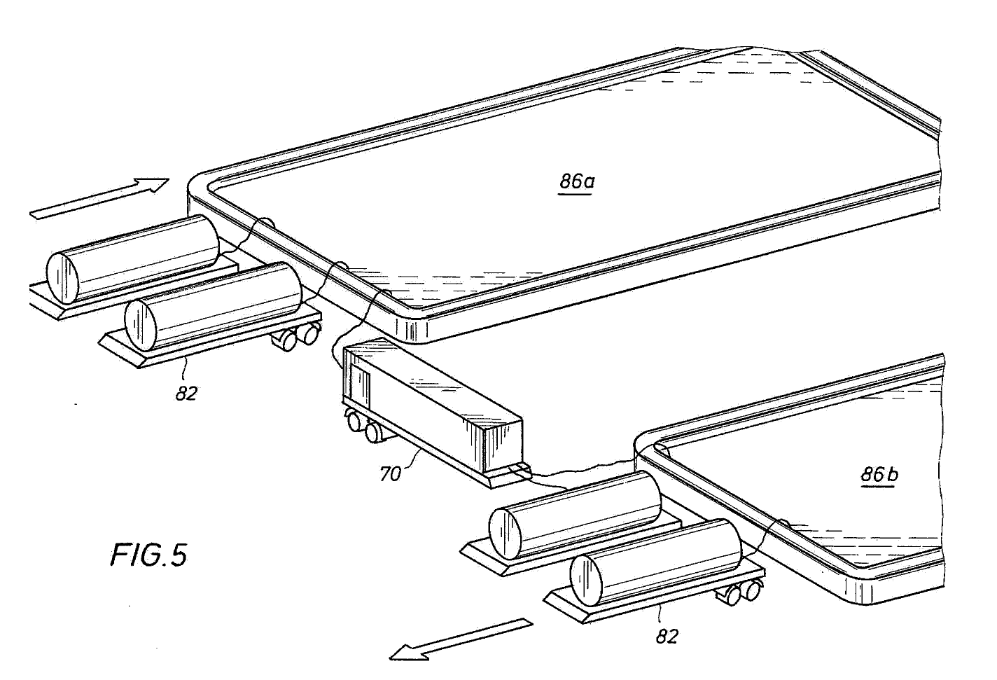

In some embodiments, the system of the present invention also may comprise a reservoir for untreated water and/or a reservoir for treated water, as illustrated in FIGS. 4 and 5. A reservoir may comprise, for example, a tank battery, a plurality of tank trucks, frac tanks, and/or trailers, a holding pit, a pond or well, and any combination thereof. As shown in FIG. 4, the system may include a plurality of mobile tank trucks 82 for bringing untreated water to an appropriate water treatment site, a trailer 70 for the water treatment equipment of the system, and a plurality of holding tanks 84 for the temporary storage of treated water. As shown in FIG. 5, the system may include a plurality of tank trucks 82 for bringing untreated water to a holding pit 86a, a trailer 70 for the water treatment equipment of the system, another holding pit 86b for the temporary storage of treated water, and a plurality of tank trucks 82 for taking treated water to a desired well location for use in well treatment operations.

In some embodiments, the reservoir for treated water may comprise an input stream to a first well treatment operation, and the reservoir for untreated water may comprise an output stream from a second well treatment operation, wherein the first and second well treatment operations may each comprise one or more well bores, and wherein the first and second well treatment operations may be separate, overlapping, or congruent. Such embodiments may be referred to as “on-the-fly water treatment systems.” It should be understood by one of ordinary skill in the art with the benefit of this disclosure that the flow rate of the output stream from the second well treatment operation must be balanced both with the flow rate of the input stream to the first well treatment operation and the flow rate of the treatment stream. In such embodiments, one or more holding reservoirs may be utilized to balance the flow rates.

Any of the methods according to the invention also may comprise one or more steps of chemically analyzing the treatment stream, for example, analyzing the concentration of at least sulfate and calcium ions upstream of centrifugal separator 18. As another example, the methods may include chemical analysis of the treatment stream for the concentrations of magnesium and iron ions. The methods also may include chemical analysis of the treatment stream for the concentration of borate. In some embodiments, it may be desirable to chemically analyze the treated water to determine and confirm the effectiveness of the methods. Still further, the analyses also may include particle size analysis. In some embodiments, such analytical information may be useful to help in troubleshooting and maintenance, for example, to determine when a filter media should be replaced with fresh filter media. Additional steps and devices may be inserted at any point in the disclosed methods or systems without departing from the scope of the present invention.

To facilitate a better understanding of the present invention, the following examples of certain aspects of some embodiments are given. In no way should the following examples be read to limit, or define, the scope of the invention.

### EXAMPLES

Man-made untreated water was created using NaCl, MgCl₂, and CaCl₂ to simulate produced water containing undesirable amounts of calcium and magnesium ions, as well as sodium and chloride ions. Additionally, in some of the tests, actual, untreated produced water was used. The untreated water was chemically treated with BA-40L^{™} or 38-42% potassium carbonate solution and MO-67^{™}, each commercially available from Halliburton Energy Services of Duncan, Okla. Seven separate samples of the chemically treated water were mechanically treated with seven different centrifuges of varying manufacturer and length-to-diameter ratio. The amount of particulate separation was observed. The results are summarized in Table 1.

TABLE 1

| | | L/D | | |
|---|---|---|---|---|
| Centrifuge Brand | Length | Ratio | Pump Rate | Results |
| US Centrifuge | 48 inches | 4.0:1 | 30 gal/min | Separation obtained |
| Hutchinson Hayes | 55 inches | 3.4:1 | 200 gal/min | Very limited |
| 5500 Decanting | | | | Separation |
| Hutchinson Hayes | 76 inches | 4.0:1 | 400 gal/min | Limited Separation |
| MegaBowl ™ | | | | |
| US Centrifuge-6″ | 65 inches | 2.6:1 | 150 gal/min | No Separation |
| single lead scroll | | | | |
| US Centrifuge-3″ | 65 inches | 2.6:1 | 150 gal/min | No Separation |
| single lead scroll | | | | |
| Andritz D4L | 63 inches | 3.7:1 | 140 gal/min | Separation obtained |
| Andritz D5L | 75 inches | 3.7:1 | 170 gal/min | Separation obtained |

Actual, untreated produced water containing undesirable amounts of calcium and magnesium ions, among others was chemically treated with a 38-42% potassium carbonate solution and MO-67^{™}. Ten separate samples of the chemically treated water were mechanically treated with the Andritz D4L centrifuge with varying pool depths. The amount of particulate separation was observed. The results are summarized in Table 2.

TABLE 2

| | K₂CO₃ | | | | | |
|---|---|---|---|---|---|---|
| Pool Depth | Soln | MO-67 ™ | Ca In | Ca Out | Mg In | Mg Out |
| (mm) | (gpt) | (gpt) | (mpL) | (mpL) | (mpL) | (mpL) |
| 220 | 50 | 10 | 6614 | 81 | 1722 | 178 |
| 220 | 50 | 10 | 8799 | 194 | 2269 | 819 |
| 220 | 40 | 8 | 6392 | 171 | 1616 | 572 |
| 220 | 50 | 0 | 4779 | 138 | 906 | 457 |
| 220 | 50 | 10 | 6537 | 80 | 1746 | 121 |
| 220 | 30 | 6 | 3830 | No Separation | 1086 | No Separation |
| 230 | 30 | 6 | 3830 | No Separation | 1086 | No Separation |
| 240 | 30 | 6 | 3830 | No Separation | 1086 | No Separation |
| 250 | 30 | 6 | 3830 | 148 | 1086 | 555 |
| 250 | 30 | 6 | 3830 | 36 | 1086 | 279 |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method of treating an untreated aqueous fluid with a first concentration of a contaminant to produce a treated water with a second concentration of the contaminant, comprising:
chemically treating the aqueous fluid to precipitate at least a portion of the contaminant, wherein chemically treating the aqueous fluid comprises adding a chemical agent to the aqueous fluid; and
mechanically treating the aqueous fluid to remove at least some of the precipitated contaminant from the aqueous fluid, wherein mechanically treating the aqueous fluid comprises flowing the aqueous fluid through a centrifuge.

2. The method of claim 1, wherein the chemical agent is added at a concentration between about 100% and about 120% on a Molar basis of the first concentration of the contaminant.

3. The method of claim 1, wherein:
the contaminant comprises sulfate; and
the chemical agent comprises at least one chemical agent selected from the group consisting of: a calcium, a strontium, a barium halide, and a derivative thereof.

4. The method of claim 1, wherein:
the contaminant comprises at least one ion selected from the group consisting of: a calcium ion, a strontium ion, a barium ion, and a derivative thereof; and
the chemical agent comprises a carbonate.

5. The method of claim 4, wherein the carbonate comprises at least one compound selected from the group consisting of: a water soluble carbonate, a compound comprising a carbon dioxide and a hydroxide, and a derivative thereof.

6. The method of claim 1, wherein:
the contaminant comprises at least one ion selected from the group consisting of: a calcium ion, a strontium ion, a barium ion, and a derivative thereof; and
the chemical agent comprises a water soluble sulfate.

7. The method of claim 1, wherein:
the contaminant comprises at least one ion selected from the group consisting of: a magnesium ion, an iron ion, and a derivative thereof; and
the chemical agent comprises at least one chemical agent selected from the group consisting of: a hydroxide, a water-soluble alkali metal hydroxide, a alkaline earth metal hydroxide, and a derivative thereof.

8. The method of claim 1, further comprising chemically analyzing the aqueous fluid to determine a type and a concentration of the chemical agent to add when chemically treating the aqueous fluid.

9. The method of claim 1, further comprising adding a pH increasing agent to the aqueous fluid.

10. The method of claim 1, wherein the centrifuge comprises a solids weir.

11. The method of claim 10, wherein the centrifuge is operated in super pool conditions.

12. The method of claim 1, wherein the centrifuge comprises a length-to-diameter ratio of between about 2.5 to about 4.5.

13. The method of claim 1, wherein the aqueous fluid flows through the centrifuge at a rate between about 50 gal/min and about 170 gal/min.

14. The method of claim 1, wherein the second concentration of the contaminant is between 2% and about 70% of the first concentration of the contaminant.

15. A system for treating an untreated aqueous fluid with a first concentration of a contaminant to produce a treated water with a second concentration of the contaminant, the system comprising:
a chemical treatment subsystem capable of precipitating at least a portion of the contaminant; and
a mechanical treatment subsystem capable of removing at least some of the precipitated contaminant from the aqueous fluid, wherein the mechanical treatment subsystem comprises a centrifuge.

16. The system of claim 15, wherein the centrifuge comprises a solids weir.

17. The system of claim 15, wherein
the precipitated contaminant comprises particles larger than about 300 microns; and
the centrifuge is capable of removing at least about 50% of the particles larger than about 300 microns.

18. The system of claim 15, wherein the centrifuge comprises a length-to-diameter ratio of between about 2.5 to about 4.5.

19. A method of performing a well treatment operation comprising:
providing an untreated aqueous fluid with a first concentration of a contaminant;
chemically treating the aqueous fluid to precipitate at least a portion of the contaminant;
mechanically treating the aqueous fluid to remove at least some of the precipitated contaminant from the aqueous fluid, and to produce a treated water with a second concentration of the contaminant, wherein mechanically treating the aqueous fluid comprises flowing the aqueous fluid through a centrifuge; and
placing the treated water in a well bore of the well treatment operation.

20. The method of claim 19, wherein the untreated aqueous fluid comprises output from a second well treatment operation.
